(19) United States
(12) Patent Application Publication
(10) Pub. No.: US 2015/0091762 A1
(43) Pub. Date: Apr. 2, 2015

(54) ANTENNA DEVICE AND A COMMUNICATION DEVICE USING THE SAME

(71) Applicants: QISDA (SUZHOU) CO., Ltd., Suzhou (CN); QISDA CORPORATION, Taoyuan County (TW)

(72) Inventor: Ho-Chen Hsiao, New Taipei City (TW)

(21) Appl. No.: 14/297,634

(22) Filed: Jun. 6, 2014

(30) Foreign Application Priority Data
Sep. 27, 2013 (TW) 102135121

(51) Int. Cl. H01Q 1/52; H01Q 1/24

(52) U.S. Cl. CPC H01Q 1/526; H01Q 1/243
USPC 343/702; 343/841; 343/720

(57) ABSTRACT

An antenna device and a communication device using the same are provided. The communication device includes a circuit board, a first antenna and a metal plate. The circuit board has a first feed point electrically connected to a high frequency unit. The first antenna has a first radiation part electrically connected to the first feed point. The metal plate is electrically connected to ground and is configured to correspond to a shape of the projection of the first radiation part. There is a space between the metal plate and the first radiation part. The area of the metal plate is bigger than or substantially equal to the area of the projection of the first radiation part.

### BACKGROUND OF THE INVENTION

1. Field of the Invention

The invention relates to an antenna device and a communication device using the same, and more particularly, to an antenna device capable of reducing the specific absorption rate (SAR) and a communication device using the same.

2. Description of the Prior Art

Mobile communication devices nowadays have being following the trend of becoming smaller and thinner. Some mobile communication devices are further equipped with two antennas for simultaneously transmit/receive signals such that the applications applied can be more versatile. It should be considered, though, that the radiation of the antennas of the mobile communication device should be able to pass the test of specific absorption rate (SAR) lest a human body should absorb too much electromagnetic radiation.

Currently, three solutions are provided according to the prior art to reduced the SAR: first, reducing the SAR by lowering the conductive power of the antenna, which reduces the electromagnetic radiation. However, the efficiency of the antenna is also compromised. Second, an absorbing component is deployed near the antenna to absorb some of the electromagnetic waves to reduce the SAR. The efficiency of the antenna will also be compromised and even cost is raised. Third, a large metal piece is configured to be placed above the antenna of the communication device to block the electromagnetic waves and reduce the SAR. Cost will be raised and the efficiency of the antenna is also compromised due to the shielding of the metal piece. It is therefore a dedicated effort for the industry to reduce the SAR considering the cost factor and without effecting the efficiency of the antenna.

### SUMMARY OF THE INVENTION

The invention provides an antenna device capable of reducing the specific absorption rate (SAR) and a communication device using the same.

According to an aspect of the invention, a communication device is provided, which includes a circuit board, a first antenna, and a metal plate. The circuit board includes a first feed point electrically connected to a high frequency unit. The first antenna has a first radiation part electrically connected to the first feed point. The metal plate is electrically connected to ground and configured to correspond to a shape of the projection of the first radiation part. A space exists between the metal plate and the first radiation part. The metal plate is bigger than or substantially equal to the area of the projection of the first radiation part.

According to another aspect of the invention, an antenna device is provided to be disposed on a circuit board having a first feed point electrically connected to a high frequency unit. The antenna device includes a first antenna having a first radiation part electrically connected to the first feed point, and a metal plate electrically connected to ground and configured to correspond to a shape of the projection of the first radiation part. A space exists between the metal plate and the first radiation part. The metal plate is bigger than or substantially equal to the area of the projection of the first radiation part.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

To have better understanding of every aspects of the invention, embodiments and figures are provided as followed:

FIG. 1 is an illustration of a partial perspective view of a communication device according to a first embodiment of the invention.

FIG. 2 is an illustration of a side cross-sectional view of the communication device according to the first embodiment of the invention.

FIG. 3 is an illustration of a top view of the communication in FIG. 2.

FIG. 4 is an illustration of a top view of the circuit board in FIG. 2.

FIG. 5 is an illustration of a partial perspective view of a communication device according to a second embodiment of the invention.

FIG. 6 is an illustration of a communication device according to a third embodiment of the invention.

### DETAILED DESCRIPTION

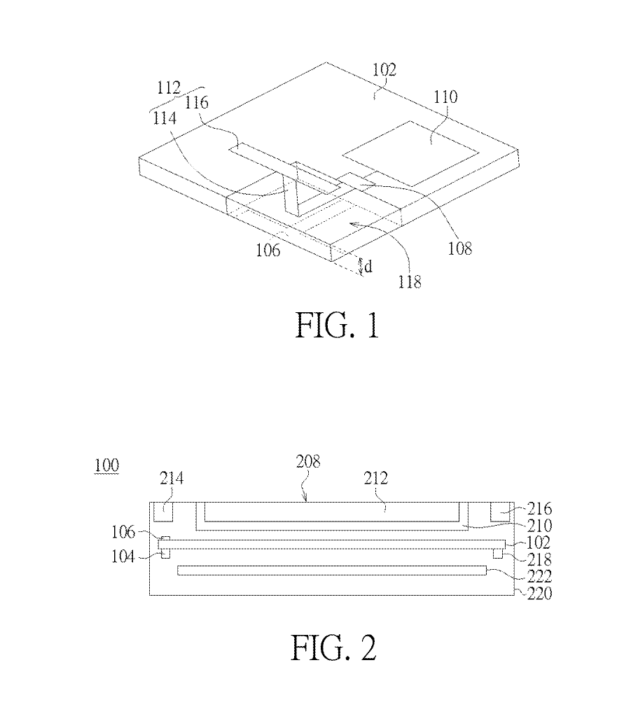

Please refer to FIG. 1 and FIG. 2. FIG. 1 is an illustration of a partial perspective view of a communication device according to a first embodiment of the invention and FIG. 2 is an illustration of a side cross-sectional view of the communication device according to the first embodiment of the invention. The communication device 100 includes a circuit board 102, a first antenna 104, and a metal plate 106. The circuit board 102 has a first feed point 108 electrically connected to a high frequency unit 110. The first antenna 104 has a first radiation part 112 electrically connected to the first feed point 108. The metal plate 106 is electrically connected to ground and is configured to correspond to a shape of the projection, and covers the projection, of the first radiation part 112. The metal plate 106 is a single planar plate and is apart from the first radiation part 112 with at least a space d. The metal plate 106 is bigger than or substantially equal to the area of the projection of the first radiation part 112. With the metal plate 106, the specific absorption rate (SAR) of the first antenna 104 can be reduced.

Capacity effect takes place between the first radiation part 112 and the metal plate 106 to gather the electromagnetic radiation therebetween and reduce the electromagnetic waves from radiating toward a direction perpendicular to the plane of the metal plate 106. Additionally, the metal plate 106 also provides metal shielding for reducing the amount of electromagnetic waves radiated toward the direction perpendicular to the plane of the metal plate 106. In such way, when the communication device 100 is in use and a user's head is close to a side of the metal plate 106, the near-field part of the electromagnetic waves radiated from the first radiation part 112 can be blocked and radiation of the electromagnetic waves to the user's head can be reduced. The near-field radiation of the embodiment can be effectively reduced such that the SAR is also reduced. The configuration of the metal plate 106 will not affect the far-field communication of the antenna and thus the antenna still maintains good efficiency when communicating with a remote radio communication device or a base station.

In the first embodiment, the high frequency unit 110 may be, for example, a signal processing circuit adapted to receive or transmit high frequency signals. The first radiation part 112 includes a resilient portion 114 and a main portion 116. The resilient portion 114 is electrically connected to the first feed point 108 and at least part of the resilient portion 114 extends along a substantially perpendicular direction relative to a top surface of the circuit board 102. The main portion 116 is strip-like with the middle connected to the resilient portion 114 and thus the resilient portion 114 and the main portion 116 form a T-shaped structure. Hence, the shape of the metal plate 106 configured to correspond to the projection of the first radiation part 112 is planar T-shaped. However, the shape of the first antenna 104 is not limited to what is mentioned and illustrated. The first antenna 104 can be any shape in such a way that the metal plate 106 can be configured to correspond to the shape of the projection of the first radiation part 112 and be implemented as a planar signal piece, and in such a way that the metal plate 106 is bigger than or substantially equal to the area of the projection of the first radiation part 112.

The circuit board 102 further includes a clearance area 118 where the first antenna 104 and the metal plate 106 are disposed corresponding to the clearance area 118. The circuit board 102 also includes a metal ground plane, which is not illustrated, and the metal plate 106 can be an extension of the metal ground plane at the clearance area 118. Accordingly, there is no additional cost for configuration of the metal plate 106 since the metal plate 106 is an extension of the metal ground plane. Additionally, the clearance area 118 would not contain any metal component that may block the electromagnetic waves.

As shown in FIG. 2, the communication device 100 further includes a first surface 208 and a display module 210. The display module 210 includes a display unit 212 to be displayed on the first surface 208. The communication device 100 further includes a speaker 214 and a microphone 216. The first antenna 104 is close to the speaker 214 and away from the microphone 216. When the user is answering a mobile device, he/she would put the speaker 214 close to his/her ear where bad influence may happen due to the antenna radiation from the antenna close to the ear. Hence, the design of the invention is particularly suitable for the antenna structure disposed near the speaker 214. The communication device 100 further includes a second antenna 218 that is disposed close to the microphone 216. In this embodiment, the metal plate 106 is disposed on the circuit board 102 positioned corresponding to the first antenna 104.

The configuration of the second antenna 218 may enhance the communication and aspect of application of the communication device 100. For example, the first antenna 104 and the second antenna 218 can be antennas corresponding to different bandwidth. One application of such can be: as the communication device 100 is performing its voice communication using the second antenna 218, the communication device 100 may use the first antenna 104 for data communication. Besides, both the first antenna 104 and the second antenna 218 can be configured as main antenna to and make use of more than one communication system such as GSM (Global System for Mobile Communications), WCDMA (Wideband Code Division Multiple Access), and LTE (Long Term Evolution). Furthermore, any single communication system can also make use of different antenna at the same time for voice communication and data communication.

The communication device 100 also includes a housing 220 and a battery 222. The housing 220 includes the first surface 208 as mentioned. The display module 210 is disposed between the housing 220 and the battery 222. The circuit board 102 is disposed between the display module 210 and the battery 222. The first antenna 104 and the second antenna 218 are disposed at two ends of the circuit board 102 positioned not overlapped with the battery 222 or the display module 110.

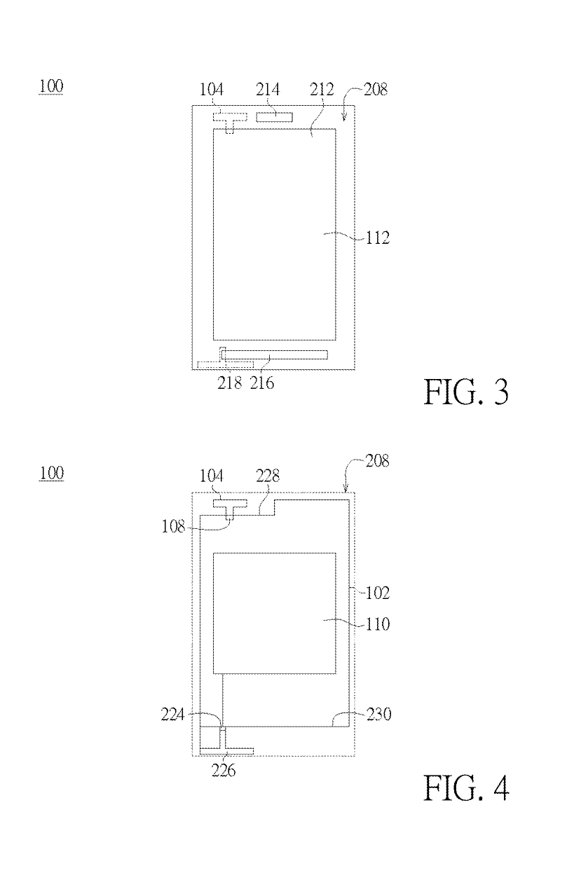

Please refer to FIG. 3 and FIG. 4 together. FIG. 3 is an illustration of a top view of the communication in FIG. 2 and FIG. 4 is an illustration of a top view of the circuit board 102 in FIG. 2. The speaker 214 and the microphone 216 are disposed at two sides, top side and bottom side for example, of the communication device 100. The circuit board 102 further includes a second feed point 224 electrically connected to the high frequency unit 110. The second antenna 218 has a second radiation part 226 electrically connected to the second feed point 224. The circuit board 102 further includes a first side 228 and a second side 230 at two ends of the circuit board 102, wherein the first feed point 108 is disposed at the first side 228 and the second feed point is disposed at the second side 230.

In an embodiment, the circuit board 102 is a multilayer printed circuit board and such printed circuit board implemented in a common mobile communication device has thickness ranging from 0.8 mm to 1 mm, with 8-10 layers. Taking the circuit board 102 as a 10-layer circuit board for an example, the printed circuit layer close to the display unit 212 is generally called the top layer, the printed circuit layer close to the first antenna 104 is generally called the bottom layer, and the printed circuit board has 2^{nd}˜9^{th} layers as the middle layers. The metal plate 106 can be disposed at one layer of the multilayer printed circuit board, which can be a direct extension of the metal ground plane or electrically connected to the metal ground plane through a via. In this embodiment, the metal plate 106 with shape similar with the area of the projection of the first antenna 104 is disposed at the top layer of the circuit board 102 above the first antenna 104 and the metal plate 106 is grounded. The grounded metal plate 106 is therefore utilized to block the electromagnetic waves and reduce the SAR.

Table 1 shows a comparison of the SAR of the antenna at various frequencies without the metal plate and with a grounded metal plate according to the embodiment of the invention, where Δ is the SAR reduced, i.e., the difference of SAR between the antenna without the metal plate and the antenna with the grounded metal plate according to the embodiment.

TABLE 1

| | Frequency (MHz) | | | | | |
|---|---|---|---|---|---|---|
| SAR (mW/g) | 1711 | 1733 | 1754 | 1850 | 1880 | 1910 |
| Without metal | 1.9 | 1.57 | 1.61 | 1.88 | 1.62 | 1.48 |
| plate | | | | | | |
| With grounded | 0.85 | 1.22 | 1.22 | 1.02 | 1.28 | 0.92 |
| metal plate | | | | | | |
| Δ | 1.05 | 0.35 | 0.39 | 0.86 | 0.34 | 0.56 |

Table 2 shows a comparison of the efficiency of the antenna at various frequencies without the metal plate and with a grounded metal plate according to the embodiment of the invention.

TABLE 2

| | Frequency (MHz) | | | | | |
|---|---|---|---|---|---|---|
| Efficiency (dB) | 1711 | 1733 | 1754 | 1850 | 1880 | 1910 |
| Without metal | −4.6 | −3.8 | −4.0 | −5.1 | −5.6 | −6.2 |
| plate | | | | | | |
| With grounded | −4.8 | −4.0 | −4 .1 | −5.3 | −5.7 | −6.4 |
| metal plate | | | | | | |

It can be acknowledged that by referring Table 1 and Table 2 presented above, the SAR of the communication device with grounded metal plate in the embodiments is smaller than the SAR of a communication device without the metal plate, considering the operational bandwidth 1711-1910 MHz. Besides, the efficiency of an antenna with the grounded metal plate is quite the same as that of an antenna without the metal plate. By using the grounded metal plate, the SAR in the embodiments can be effectively reduced so that human body may suffer less from the electromagnetic waves, while almost maintaining the efficiency of the antenna and keeping the communication device in good communication quality.

Additionally, compared with the embodiments in the invention, conventional structure reduces the SAR by reducing the conductive power. The efficiency of the antenna is compromised when the conductive power is reduced. Contrarily, structures in the embodiments of the invention are able to have its original conductive power, thereby providing good antenna efficiency.

Furthermore, compared with the conventional solution of using an absorbing component, no additional component is needed in the embodiments of the invention, which saves additional cost. Plus, the absorbing component in the conventional solution needs to be deployed manually, which is a time consuming job and deployment deviation is more likely to compromise the result of blocking the electromagnetic waves. On the contrary, the fact that the metal plate according to the embodiments of the invention is formed directly by the metal layer of the circuit board needs no additional work of deployment and also saves cost and time. Quality of the products is more stable than ever. Besides, the configuration of the absorbing component of the conventional solution not only hazards the efficiency of the antenna but adds thickness of the products, while the configuration of the metal plate of the invention is free from either effecting the efficiency of the antenna or adding thickness of the products.

Similarly, compared with the conventional way of using an additional piece to reduce the radiation, the embodiments of the invention save cost and space by using the metal plate.

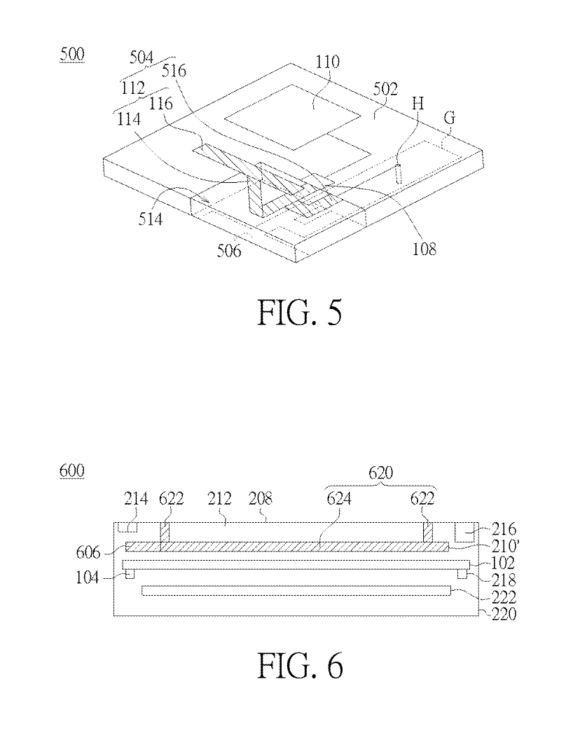

FIG. 5 is an illustration of a partial perspective view of a communication device according to a second embodiment of the invention. The communication device 500 is different from the communication device 100 in FIG. 1 in that the first antenna 504 includes a first radiation part 112 and further includes a first ground part 516, which is electrically connected to the first radiation part 112. The metal plate 506 is configured to correspond to a shape of the projection of the first antenna 504, including the first ground part 516. The circuit board 502 includes a first clearance area 514 where the first antenna 504 and the metal plate 506 are disposed corresponding to the first clearance area 514. The circuit board 502 also includes a metal ground plane G and the metal plate 506 can be an extension of the metal ground plane G at the first clearance area 514. Accordingly, there is no additional cost for configuration of the metal plate 506 since the metal plate 506 is an extension of the metal ground plane G. In other embodiment, the metal plate 506 can also be an extension of one layer of a multilayer printed circuit board at the first clearance area 514 and the metal plate 506 is electrically connected to the metal ground plane G through a via H.

FIG. 6 is an illustration of a communication device according to a third embodiment of the invention. The communication device 600 is different from the communication device 100 in FIG. 2 in that the display module 210′ further includes a metal frame 620 disposed above the circuit board 102. The metal frame has four sides 622 connected to a bottom side 624 and the metal frame 620 is utilized for containing a display unit 212. The metal plate 606 can be an extension of the metal bottom side 624 and no further cost of disposing the metal plate 606 is needed since the metal plate 606 is an extension of the metal bottom side 624. The metal plate 606 is configured to correspond to a shape of the projection of the first radiation part 112, and the metal plate 606 is bigger than or substantially equal to the area of the projection of the first radiation part 112.

By configuring a metal plate corresponding to an area of the projection of a first radiation part of a first antenna, the communication device according to the invention effectively reduces the SAR by blocking the electromagnetic waves from the human body. Compared with the conventional solution, The communication device according to the invention substantially maintains the efficiency of the antenna and needs no further cost as the SAR is effectively reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
a circuit board having a first feed point electrically connected to a high frequency unit;
a first antenna having a first radiation part electrically connected to the first feed point; and
a metal plate electrically connected to ground and configured to correspond to a shape of the projection of the first radiation part, a space existing between the metal plate and the first radiation part, the metal plate bigger than or substantially equal to the area of the projection of the first radiation part.

2. The communication device of claim 1, further comprising:
a first surface; and
a display module having a display unit to be displayed on the first surface, wherein the metal plate is disposed between the first surface and the first antenna.

3. The communication device of claim 2, wherein the display module further comprising a metal frame for containing the display unit, wherein the metal plate is an extension of the metal frame.

4. The communication device of claim 3, wherein the metal frame comprises four sides connected to a metal bottom side, and the metal plate is the extension of the metal bottom side.

5. The communication device of claim 2, wherein the circuit board comprises a first clearance area, and the first antenna and the metal plate are disposed corresponding to the first clearance area.

6. The communication device of claim 5, wherein the circuit board further comprises a metal ground plane, and the metal plate is an extension of the metal ground plane at the first clearance area.

7. The communication device of claim 6, wherein the first antenna further comprises a first ground part electrically connected to the metal ground plane, and the first ground portion is electrically connected to the first radiation part.

8. The communication device of claim 5, wherein the circuit board is a multilayer printed circuit board, wherein the metal plate is an extension of one layer of the multilayer printed circuit board at the clearance area.

9. The communication device of claim 1, further comprising a speaker wherein the first antenna is close to the speaker.

10. The communication device of claim 9, wherein the circuit board further comprises a second feed point electrically connected to the high frequency unit, the communication device further comprising:
a second antenna having a second radiation part electrically connected to the second feed point; and
a microphone, wherein the second antenna is close to the microphone.

11. The communication device of claim 10, wherein the circuit board further comprises a first side and a second side at two ends of the circuit board, wherein the first feed point is disposed at the first side and the second feed point is disposed at the second side.

12. The communication device of claim 11, further comprising:
a housing having a first surface;
a display module having a display unit to be displayed on the first surface; and
a battery wherein the display module is disposed between the housing and the battery, the circuit board is disposed between the display module and the battery, and the first antenna and the second antenna are disposed at two ends of the circuit board positioned not overlapped with the battery or the display module.

13. The communication device of claim 9, further comprising a microphone, wherein the first antenna is away from the microphone.

14. The communication device of claim 1, wherein the first radiation part comprises a resilient portion and a main portion, the resilient portion electrically connected to the first feed point, at least part of the resilient portion extending along a substantially perpendicular direction relative to a top surface of the circuit board, the main portion being strip-like with the middle connected to the resilient portion and thus the resilient portion and the main portion forming a T-shaped structure.

15. The communication device of claim 14, wherein the metal plate is planar T-shaped.

16. An antenna device, disposed on a circuit board having a first feed point electrically connected to a high frequency unit, the antenna device comprising:
a first antenna having a first radiation part electrically connected to the first feed point; and
a metal plate electrically connected to ground and configured to correspond to a shape of the projection of the first radiation part, a space existing between the metal plate and the first radiation part, the metal plate bigger than or substantially equal to the area of the projection of the first radiation part.

17. The antenna device of claim 16, wherein the metal plate is an extension of a metal frame, and the metal frame contains a display unit and is disposed on the circuit board.

18. The antenna device of claim 17, wherein the circuit board comprises a first clearance area, and the first antenna and the metal plate are disposed corresponding to the first clearance area.

19. The antenna device of claim 18, wherein the circuit board further comprises a metal ground plane, and the metal plate is an extension of the metal ground plane at the first clearance area.

20. The antenna device of claim 18, wherein the circuit board is a multilayer printed circuit board, the circuit board further comprises a metal ground plane, wherein the metal plate is an extension of one layer of the multilayer printed circuit board at the clearance area and the metal plate is electrically connected to the metal ground plane through a via.
